(19) United States
(12) Patent Application Publication
(10) Pub. No.: US 2013/0073671 A1
(43) Pub. Date: Mar. 21, 2013

(54) OFFLOADING TRAFFIC TO DEVICE-TO-DEVICE COMMUNICATIONS

(71) Applicants: Vinayak Nagpal, Berkeley, CA (US); Sayantan Choudhury, Berkeley, CA (US); Klaus Doppler, Albany, CA (US)

(72) Inventors: Vinayak Nagpal, Berkeley, CA (US); Sayantan Choudhury, Berkeley, CA (US); Klaus Doppler, Albany, CA (US)

(21) Appl. No.: 13/234,121

(22) Filed: Sep. 15, 2011

(51) Int. Cl. G06F 15/16

(52) U.S. Cl. 709/217

(57) ABSTRACT

Methods and apparatus, including computer program products, are provided for offloading data to D2D communication links. The method may include processing information indicating at least one or more data locations representing at least one or more candidate locations where data is stored; determining at least one or more device locations representing one or more devices accessible by a wireless device-to-device communication link; determining, based on the one or more data locations and the one or more device locations, a local device from which to access the data; and accessing the data at the determined local device. Related apparatus, systems, methods, and articles are also described.

### FIELD

The subject matter described herein relates to wireless communications.

### BACKGROUND

There are various types of networks, including infrastructure networks (e.g., the internet, cellular networks, and the like), ad-hoc networks, or a combination of both. In the case of the infrastructure network, the user equipment communicates (e.g., transmits and/or receives) with another user equipment through an access point, such as base station or a wireless access point. In the case of the ad-hoc network, the user equipment communicates directly with another user equipment. Ad hoc networks are also called device-to-device (D2D) networks, referring to the wireless direct link(s) between a plurality of user equipment. In the case of ad-hoc, D2D communications, some of the D2D communications are also controlled by a base station, providing so-called “cellular controlled” D2D communications (which is also referred to as cellular assisted D2D communications). In cellular controlled D2D communications, two devices may be directly linked via a D2D connection, and the devices may be attached to a base station, such as an enhanced Node B (eNB) base station, to exchange control information with the eNB (or other nodes of the network).

Today's cellular networks provide wide area network access to a variety of resources that at one time were available only to wired Internet users. Email, social networking, photo sharing, music sharing, streaming video, and cloud services are just a few examples of internet resources now available to the user equipment of cellular networks. However, this increased breadth of available resources has dramatically increased the traffic carried on cellular networks including the Internet.

### SUMMARY

Methods and apparatus, including computer program products, are provided for offloading traffic. In one aspect, there is provided a method. The method may include processing information indicating at least one or more data locations representing at least one or more candidate locations where data is stored; determining at least one or more device locations representing one or more devices accessible by a wireless device-to-device communication link; determining, based on the one or more data locations and the one or more device locations, a local device from which to access the data; and accessing the data at the determined local device.

In some variations of some of the embodiments disclosed herein, one or more of the following may be included. A request for the data may be sent. A server may send the information indicating at least the one or more data locations. The information indicating at least the one or more data locations may be received. The information indicating at least the one or more data locations may include one or more identifiers of the one or more devices. The information indicating at least the one or more data locations may include a cache device set. A local device set may be generated by listening for the one or more devices. The one or more data locations and the one or more device locations may be compared to determine the local device. At least one device-to-device communication link may be created to access the data at the determined local device. The one or more devices may include user equipment.

In another aspect, there is provided a method. The method may include storing, at a server, information indicating at least one or more data locations representing at least one or more candidate locations where data is stored in one or more user equipment; and sending, by the server, the information to enable a determination, based on the one or more data locations and one or more user equipment locations, of a local user equipment from which to access the data.

In some variations of some of the embodiments disclosed herein, one or more of the following may be included. The local user equipment may be accessed via a wireless device-to-device communication link. The server may send a request for one or more user equipment locations to enable the server to determine the local user equipment from which to access the data. The server may register the one or more user equipment.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts a block diagram of a wireless communication system in accordance with some exemplary embodiments;

FIG. 2A depicts a process for offloading content to device-to-device wireless links in accordance with some exemplary embodiments;

FIG. 2B depicts another process for offloading content to device-to-device wireless links in accordance with some exemplary embodiments;

FIG. 3 depicts an example of a user equipment in accordance with some exemplary embodiments; and

FIG. 4 depicts an example of a server in accordance with some exemplary embodiments.

Like labels are used to refer to same or similar items in the drawings.

### DETAILED DESCRIPTION

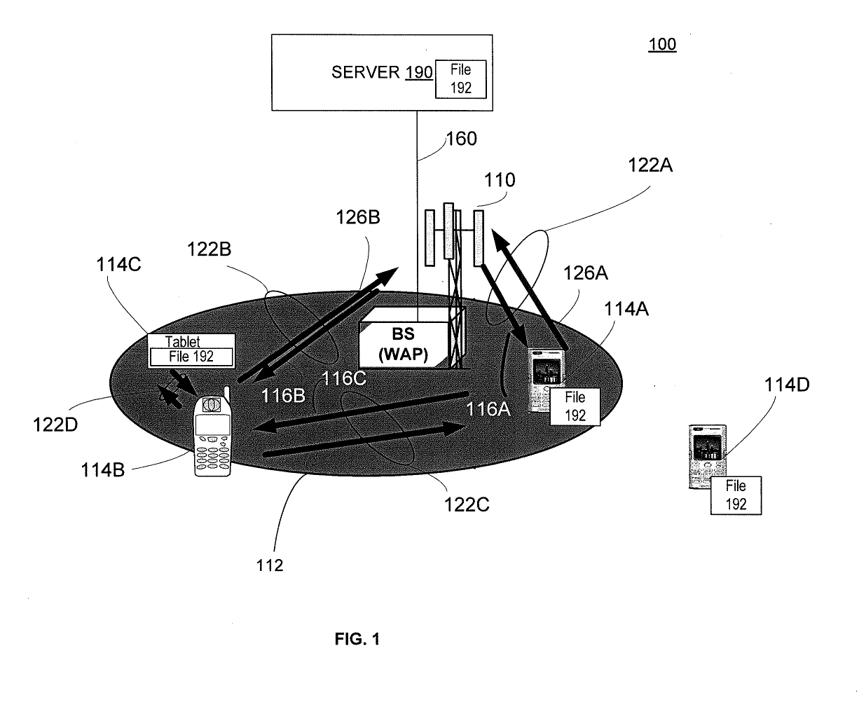

The subject matter described herein relates to mechanisms for offloading traffic from a wide area network, such as an infrastructure network, a cellular network and/or the internet, to another network, such as device-to-device communication links. Before providing a detailed description of those mechanisms, FIG. 1 provides a general description of the system environment in which the offloading mechanisms may be implemented.

FIG. 1 is a simplified functional block diagram of a wireless communication system 100 in accordance with some exemplary embodiments. The wireless communication system 100 may include a server, such as a server 190, coupled via a link 160 (e.g., backhaul links, the internet, and the like) to a base station 110 supporting a corresponding coverage area 112 (which may also be referred to as a cell).

The server 190 may include content that can be offloaded from the cellular network including the internet to D2D communication links. In some exemplary embodiments, the server 190 may be implemented as a server that provides information, such as content, services, and the like, when requested by a user or a client. For example, the server 190 may be implemented as a cloud server, such as a web site or a portal, that allows storage, hosting, execution, and/or use of cloud computing resources provided via the cloud server. An example of a cloud server may be a server that provides services, such as word processing, email, voice mail, and the like via the internet without requiring the user to download to the user equipment the underlying application for word processing, email, voice mail, and the like as those application remain in the cloud server. Other examples of services that can be provided by the server 190 include social networking, photo sharing, music sharing, streaming video, and the like. Although server 190 may be implemented in a variety of ways, in some exemplary embodiments, the server 190 is implemented as a cloud server providing one or more of the following: software-as-a-service (SaaS), infrastructure-as-a-service (IaaS), and/or platform-as-a-service (PaaS).

In some exemplary embodiments, the server 190 may determine the locality of data, while the user equipment determines the locality of other devices, such as user equipment. For example, the locality of the data may represent a mapping between various data resources (which may be provided by the server 190) and a plurality of user equipment that have the latest copy of a given data resource in the local cache of a given user equipment, while the locality of devices may represent a list (which may be maintained at a given user equipment) of other user equipment that are in the local vicinity and accessible for connection requests via D2D communications. Moreover, the locality of data and the locality of other devices may be used to determine the set of devices where the data may be accessed directly via D2D communication links. For example, the server 190 may receive from user equipment 114B a request for a file, such as file 192. In this example, the server 190 may determine the locality of the requested data, such as file 192, by determining that the requested data is also located in the memory (e.g., cache) of user equipment 114A, C, and D, and the user equipment 114B determines the locality of other devices by discovering which devices are local to, and thus accessible from, user equipment 114B by D2D communication links. In the example of FIG. 1, the user equipment 114B may determine that user equipment 114A and C are local. As such, the data request for file 192 may be routed to user equipment 114B, so that user equipment 114B can access the requested file locally either at user equipment 114A or C, rather than access file 192 at server 190. In addition, the data retrieval of file 192 at server 190 is offloaded, in this example, to local D2D communications. In some exemplary embodiments, this offloading may be performed in a manner that is transparent to the user, although the user may be given the option to enable or disable the offloading via D2D communication links.

In some exemplary embodiments, the base station 110 may be capable of communicating with wireless devices, such as user equipment 114A-C, within the coverage area 112. In the example of FIG. 1, user equipment 114D is not within the coverage area 112, so user equipment 114D would be serviced by another base station. In some implementations, the base station 110 may be configured as an evolved Node B (eNB) type base station consistent with standards, including the Long Term Evolution (LTE)/LTE-Advanced standards, and any subsequent additions or revisions to these and other 3GPP series of standards (collectively referred to as LTE standards), although the base station may be implemented in accordance with other standards and technologies as well.

The wireless communication system 100 may include access links, such as access links 122A-B, between the base station and the user equipment. The access links 122A-B may also include a downlink, such as downlinks 116A and 116B, for transmitting from the base station 110 to a corresponding user equipment. The access links 122A-B may also include an uplink, such as uplinks 126A and 126B, for transmitting from the user equipment to the base station. The wireless communication system 100 may further include device-to-device (D2D) communication links, such as D2D links 122C-D, between the user equipment 114A-B and user equipment 114B-C. Although the example of FIG. 1 shows user equipment 114D without a D2D link to another user equipment, a D2D link may be established between user equipment 114A to user equipment 114D when the two devices are local and thus accessible even when user equipment 114D is in another cell.

Although the base station 110 is described as an eNB base station, the base station may be configured in other ways as well and include, for example, cellular base station transceiver subsystems, gateways, access points, radio frequency (RF) repeaters, frame repeaters, nodes, servers, cloud servers, web sites, and include access to other networks. For example, base station 110 may have wired and/or wireless backhaul links including network/internet connections to other network nodes, such as other base stations, a radio network controller, a core network, a serving gateway, a mobility management entity, a serving GPRS (general packet radio service) support node, location servers, servers, cloud servers, web sites, and the like.

Moreover, although base station 110 is described as a cellular, eNB base station, base station 110 may also be implemented as a wireless access point, such as a Wi-Fi local area network wireless access point. When base station 110 is implemented as a wireless access point, the uplinks and downlinks between the wireless access point and the user equipment 114A-C may be implemented as links configured in accordance with, for example, Wi-Fi, WiGig, and any wireless local area network standard.

The user equipment 114A-D may be mobile and/or stationary. Moreover, the user equipment 114A-D may be referred to as, for example, devices, mobile stations, mobile units, subscriber stations, wireless terminals, terminals, tablets, and/or any other wireless device. The user equipment may be implemented as, for example, a wireless handheld device, a wireless plug-in accessory, or the like. For example, the user equipment may take the form of a wireless phone, a computer with a wireless connection to a network, or the like. In some cases, the user equipment may include one or more of the following: at least one processor, at least one computer-readable storage medium (e.g., memory, storage, and the like), a user interface, and radio access mechanisms for cellular networks, D2D communication links, and/or local area networks.

Although FIG. 1 depicts a single base station 110 (or wireless access point), a single coverage area 112, and four user equipment 114A-D, other quantities of base stations/wireless access points, coverage areas, and user equipment may be implemented as well.

Moreover, in some implementations, the links 122C-D between user equipment 114A-B and user equipment 114B-C may be configured as D2D links in accordance with a standard, such as Bluetooth, Wi-Fi direct, WiGig-based D2D communications, LTE-based D2D communications, and/or any other D2D standard. On the other hand, links 122A-B may be configured in accordance with LTE, LTE-Advanced, and/or any other cellular network standard, wireless local area network standard, and/or internet standard.

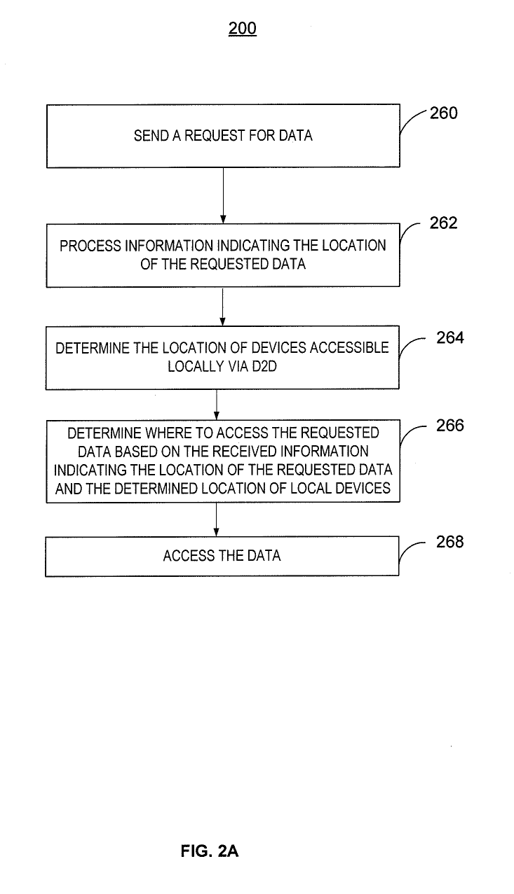

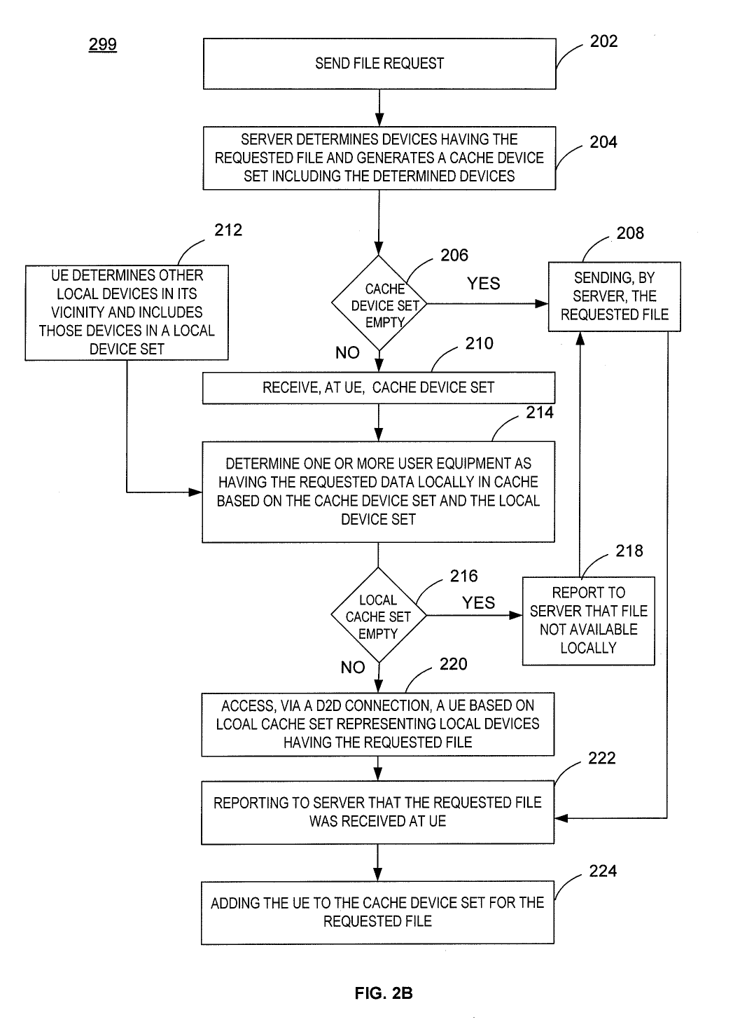

FIG. 2A depicts an example process 200 for offloading content from a first network to a second network including D2D links in accordance with some exemplary embodiments. The description of FIG. 2A also refers to FIG. 1.

In some exemplary embodiments, a data request may be sent at 260. For example, the user equipment 114B may send to server 190 via links 122B and 160 a request for data, such as file 192 served by server 190. The requested data may correspond to a data file, a music file, streaming video, social networking content, content from a cloud service, and any other form of information. The request may also be a request to provide content to, or share content with, another user equipment. For example, user equipment 114B may send a request to server 190 to enable sharing file 192 with user equipment 114A.

To provide data, such as the data requested at 260, a device may determine the locality of the requested data by, for example, assessing where the requested data is available locally via D2D communication links. For example, server 190 may include information indicating whether the requested data is available at other locations, such as the user equipment 114A-D. In some implementations, the server 190 may require user equipment 114A-D to register for content, and then assign an identifier to each user equipment 114A-D. In this example, the server 190 may maintain a record of the identifiers of the user equipment 114A-D and a record of the server's 190 content currently available in the memory, such as cache, of the user equipment 114A-D. The identifiers may be implemented as any form of identifier, but in some implementations, the user equipment identifier may be implemented as a media access control (MAC) address. In some exemplary embodiments, each application may generate a set of device identifiers IDs, which may be implemented as MAC addresses and/or any other type of identifier.

Table 1 depicts an example of the information stored at a device, such as server 190, to enable determining the locality of data, such as file 192. Referring to Table 1, for each file, such as file 192 and file Zxx, the server 190 may maintain a record of the unique identities of any user equipment where the corresponding file is stored. In the example of Table 1, the unique identities are maintained in a cache device set, although the information depicted in Table 1 may be stored in other formats as well.

TABLE 1

| File | Cache Device Set |
|---|---|
| File 192 | user equipment 114A, MAC address X |
| | user equipment 114C, MAC address Y |
| | user equipment 114D, MAC address Z |
| File Zxx | user equipment 114B, MAC address Z1 |
| | user equipment 114D, MAC address Z |

In some exemplary embodiments, a device may process, at 262, information indicating data locations representing candidate locations where the requested data is stored. For example, a device, such as user equipment 114B, may receive and/or process information indicating the location of the data requested at 260. This information may be implemented as, for example, identifiers of user equipment where the requested data may be located, and, in some exemplary embodiments, may be configured as a cache device set. For example, user equipment 114B may process the cache device set defining that the data requested at 260 may be obtained by user equipment 114B by accessing memory at the user equipment corresponding to identifiers X, Y, and Z, which in the example of Table 1 corresponds to the MAC addresses of user equipment 114A, C, and D.

In some exemplary embodiments, the locality of devices may be determined at 264 by determining whether devices are accessible directly via D2D communication links. For example, a device, such as user equipment 114B, may discover other user equipment (which are local and accessible via D2D communications) by listening for a broadcast of their identifiers. In some exemplary embodiments, the user equipment 114B may also generate a local device set defining which user equipment are local and accessible via D2D communications. This local device set may list the identifiers of any user equipment accessible from user equipment 114B via D2D links. For example, the local device set may include identifiers, such as MAC addresses, for user equipment 114A and C. Table 2 depicts an example of a local device set determined by user equipment 114B.

TABLE 2
User Equipment 114B Local Device Set

user equipment 114A, MAC address X
user equipment 114C, MAC address Y

In some exemplary embodiments, one or more devices may be determined, at 266, as having the requested data locally in cache based on the locality of data information indicating the location of the requested data and the locality of devices information indicating the location of devices accessible via D2D communication links. For example, the cache device set received at 262 may indicate that user equipment 114A, C and D includes the data 192 requested in 260 and the local device set determined at 264 may also indicate that user equipment 114A and C are accessible via D2D links. In this example, the user equipment 114B processes the cache device set and the local device set to determine that the data requested at 260 might be obtained via D2D communications to user equipment 114A and/or 114C.

Although FIG. 2A described the user equipment processing the cache device set and the local device set, in some exemplary embodiments, the server 190 may also process the cache device set and the local device set (which would be sent by the user equipment 114B to server 190) to determine that the data requested at 260 may be obtained via D2D communications to user equipment 114A and/or 114C, and these results are sent to the user equipment 114B to enable the user equipment to access the data at user equipment 114A and/or 114C via D2D communications. In some exemplary embodiments, a D2D offload mode as described herein may be configured to enable the server 190 and/or a base station to control what information is actually exchanged over D2D links between devices. For example, if server 190 is congested, the server 190 may direct one or more user equipment to use the D2D offload mode to obtain information.

At 268, the requested data may be obtained in accordance with some exemplary embodiments by creating access to the requested data via D2D communications. Returning to the previous example, user equipment 114B may directly access the file 192 stored in the cache of user equipment 114A and/or 114C via D2D communications, rather than download the file 192 from server 190. If the user equipment 114B determines that the data is not actually at user equipment 114A or 114C (or the content is stale or otherwise not suitable), the user equipment 114B may re-request the data, such as file 192, from server 190 and indicate that the local content was not available or not suitable, in which case the server 190 may respond directly with the requested data, such as file 192.

Although the description of FIG. 2A refers to the user equipment sending at 260 a data request to server 190 to obtain the requested data, in some exemplary embodiments, the server 190 may push the information at 262, without a data request being made at 260. Moreover, although the description of FIG. 2A refers to some aspects of process 200 occurring at a user equipment and/or a server, aspects of process 200 may also be performed in other devices as well as a combination of devices.

FIG. 2B depicts another example process 299 for offloading content to D2D links consistent with some exemplary embodiments. The description of FIG. 2B also refers to FIG. 1.

In some exemplary embodiments, the user equipment may send, at 202, a file request to a server. For example, user equipment 114B may send a request, such as a hypertext transfer protocol request (html), to server 190 to obtain a specific file, such as file 192. The request may be sent via link 126B, base station 110, and link 160 including the internet.

In some exemplary embodiments, the server 190 may determine, at 204, any devices having the specific file requested at 202. In some exemplary embodiments, the server 190 may determine which user equipment has a copy of the requested file stored locally (e.g., at the user equipment). For each file served by the server 190, the server 190 may store information indicating the files served by the server 190 and whether those files are also available at the user equipment. For example, for a specific file 192 being requested and served by server 190, the server 190 may also have an associated set of user equipment identifiers indicating any devices where file 192 is located. Table 1 above is an example of information maintained at server 190 for each file served by server 190, although the information of Table 1 indicating the location of the data may be stored in other formats as well.

In some exemplary embodiments, the identifier of user equipment may be assigned by the server 190 to distinguish among other user equipment registered at server 190, although in some embodiments the identifier may also include the MAC address. When user equipment has multiple identifiers, the server 190 may associate any files stored locally in the cache of the identifiers with the multiple identifiers, such as multiple application layer identifiers. Moreover, a unique application layer identifier may be used to identify a device, and the application identifier may be independent of the physical device identifiers. Furthermore, the identifier may be unique at least in a given locality of devices such that there is no conflict (e.g., where the identifiers are reused in devices when those devices are too far apart to initiate direct or multihop D2D connections.

In some exemplary embodiments, the server 190 may generate, at 204, a cache device set indicating which devices have the requested file stored locally at the device. Returning the example of a file request for file 192, the server 190 may determine that user equipment 114A, C and D have file 192 stored locally in, for example, cache memory. In this example, the cache device set for requested file 192 includes identifiers for user equipment 114A, C, and D.

In some exemplary embodiments, if the cache device set is empty (yes at 206), the server 190 may send, at 208, the requested file 192 to the user equipment 114B which sent the file request at 202. However, if the cache device set is not empty (no at 206), the server 190 may send the cache device set to the user equipment 114B which made the file request at 202. In some implementations, the server 190 may send the cache device set as a message via link 160, base station 110, and link 116B.

In some exemplary embodiments, the cache device set may be received at 260. For example, the cache device set sent by the server 190 may be received at user equipment 114B via link 160, base station 110, and link 116B.

At 212, the user equipment may determine whether any other user equipment are local (e.g., accessible by D2D communications) and then include those devices in a local device set in accordance with some exemplary embodiments. For example, user equipment 114B may execute a discovery protocol and determine that user equipment 114A and C are accessible by D2D communication links, such as a Bluetooth, Wi-Fi direct, WiGig-based D2D communications, LTE-based D2D communications, and/or any other wireless local area network standard. Moreover, user equipment 114B may also determine that user equipment 114D is not currently accessible by D2D communication links. In this example, user equipment 114B may generate a local device set including user equipment 114A and C. To discover what devices are accessible locally by D2D communications, each user equipment 14A-D may advertise or broadcast its identifier to enable a user equipment to ascertain what devices are local, and this advertisement/broadcast may occur over multiple wireless local area network radio interfaces, such as Bluetooth, Wi-Fi Direct, WiGig-based D2D communications, and/or LTE based D2D. In some implementations, the same identifier for the user equipment may be used across all of these interfaces.

In some exemplary embodiments, one or more user equipment may be determined, at 214, as having the requested data locally in cache based on the cache device set and the local device set. As such, the user equipment may access the data requested at 202 via D2D communications based on data locality information determined by the server 190 and device locality information determined by the user equipment. For example, the user equipment 114B may determine the location(s) of the requested file based on the intersection of the local device set determined at 212 and the cache device set determined at 206. If the local device set determined at 212 indicates that user equipment 114A and C are accessible by D2D communications and the cache device set determined at 206 indicates user equipment 114A, C and D have the file requested at 202, then the intersection represents user equipment 114A and C, which are locations where the requested file can be accessed locally via D2D communications.

In some exemplary embodiments, the user equipment 114B may also generate a local cache set representing the set of user equipment corresponding to the intersection of the local device set and the cache device set. Returning to the previous example, the user equipment 114B may generate, for a specific file 192, a local device set including user equipment 114A and C, which are locations where the requested file can be accessed locally via D2D communications.

In some exemplary embodiments, if the local cache set is empty (yes at 216), the user equipment 114B may report, at 218, to the server 190 that the file requested at 202 is not available locally via D2D communications, in which case the server 190 sends, at 208, the requested file 192 to the user equipment 114B. However, if the local cache set is not empty (no at 216), the user equipment 114B may directly access the data file 192 locally via D2D communications.

At 220, the user equipment 114B may, in some exemplary embodiments, access the file requested at 202 based on information, such as the local cache set indicating where the requested file can be obtained via D2D links. Returning to the previous example, if the local device set indicates that user equipment 114A and C are accessible by D2D communication links and the cache device set indicates user equipment 114A, C and D have the file requested at 202, then the local cache set indicates that user equipment 114A and C include the requested file 192 which is accessible directly via D2D communications. In this example, user equipment 114B may couple via D2D communications to user equipment 114A and/or user equipment 114C to obtain (e.g., retrieve and/or receive) the file 192. As such, user equipment 114B is able to obtain file 192 from user equipment 114A and/or 114C, rather than server 190, offloading traffic associated with file 192 from the wide area network, such as the cellular network and/or internet accessed via base station 110 (or wireless access point), to local D2D communications.

In some exemplary embodiments, the user equipment may report, at 222, to server that the requested file was obtained. For example, user equipment 114B may send a message to server 190 indicating that the file 192 requested at 202 has been obtained.

At 224, the server may, in some exemplary embodiments, update file location information. The server 190 may update its file location information for file 192 to indicate that file 192 is also available at user equipment 114B. For example, server 192 may update the cache device set, such as Table 1 above, to include user equipment 114B, when file 192 is obtained and stored in memory at user equipment 114B.

To illustrate an example use of process 299, suppose two users, A and B, at user equipment 114A and B are within the same room and user A at user equipment 114A wants to share a file with user B at user equipment 114B. This file may be stored on a cloud service at server 190. Moreover, the user A may be registered with server 190, and the server 190 may be synchronized with respect to any content cached at user equipment 114A. If user A wants to share the file with user B, user equipment 114A may send to user equipment 114B an email including an attachment or a hyper text markup language link identifying the cloud server 190. This link may be sent or shared using a variety of mechanisms including email, short message service, and/or social networking (e.g., Facebook, Twitter, etc.). When user B at user equipment 114B receives the link and accesses it, process 299 may be used by the server 190 and the user equipment 114B to detect whether the request for the file can be retrieved locally via D2D links rather than via the wide area network, such as the internet/cellular networks. Other examples include media servers that cache videos from a video streaming website, such as YouTube or Netflix, to user equipment memory, and then the cached videos are routed automatically via process 299 to one or more user equipment coupled by D2D links—offloading thus the video traffic from the Internet to the D2D links.

In some implementations, the cache device set may be relatively large, in which case the server 190 may request the user equipment to send its local device set, so that the server 190 may determine the devices common to both the cache device set and the local device set. Moreover, the server 190 and user equipment may also exchange portions of the cache device set rather than the complete cache device set. For example, if the request at 202 is received from an Internet protocol (IP) address based in North America, the server 190 may omit sending any devices on the cache device set that are outside of North America. In some exemplary embodiments, other heuristic methods may be used to limit the size of the cache device set and local cache set. For example, the user equipment may send its location (e.g., latitude and longitude obtained from a global positioning system receiver) to the server 190, where the location is stored along with the location of other user equipment. The server 190 may then eliminate one or more user equipment from the cache device set when the calculated distance of the user equipment making the request at 202 to other user equipment is too far to support a D2D link.

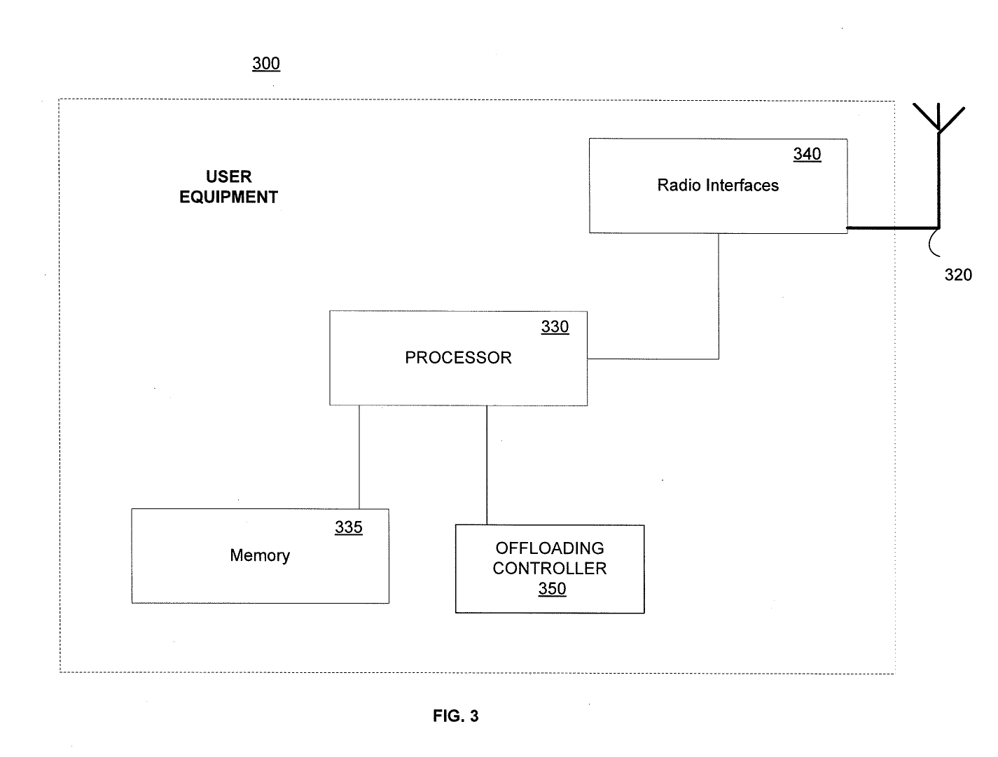

FIG. 3 depicts an exemplary user equipment 300, which may be implemented at one or more of user equipment 114A-D. The user equipment may include one or more antennas 320 coupled to a radio interface 340. The radio interface 340 may include one or more interfaces to other devices and/or networks, such as infrastructure networks, internet access provided via wireless access points, cellular networks including base stations, wide area networks, local area networks, personal area networks, D2D communication links (e.g., Bluetooth, Wi-Fi direct, WiGig-based D2D communications, LTE-based D2D communications, and/or any other D2D standard), and the like. The radio interface 340 may include other components, such as filters, converters (e.g., digital-to-analog converters and the like), symbol demappers, transforms, and the like. The user equipment may further include a processor 330 for controlling the user equipment and for accessing and executing program code stored in memory 335. Furthermore, the user equipment may include an offloading controller 350. In some exemplary embodiments, the offloading controller 350 may perform one or more of the D2D offloading related mechanisms described herein including determining the locality of devices accessible via D2D communications, and the like.

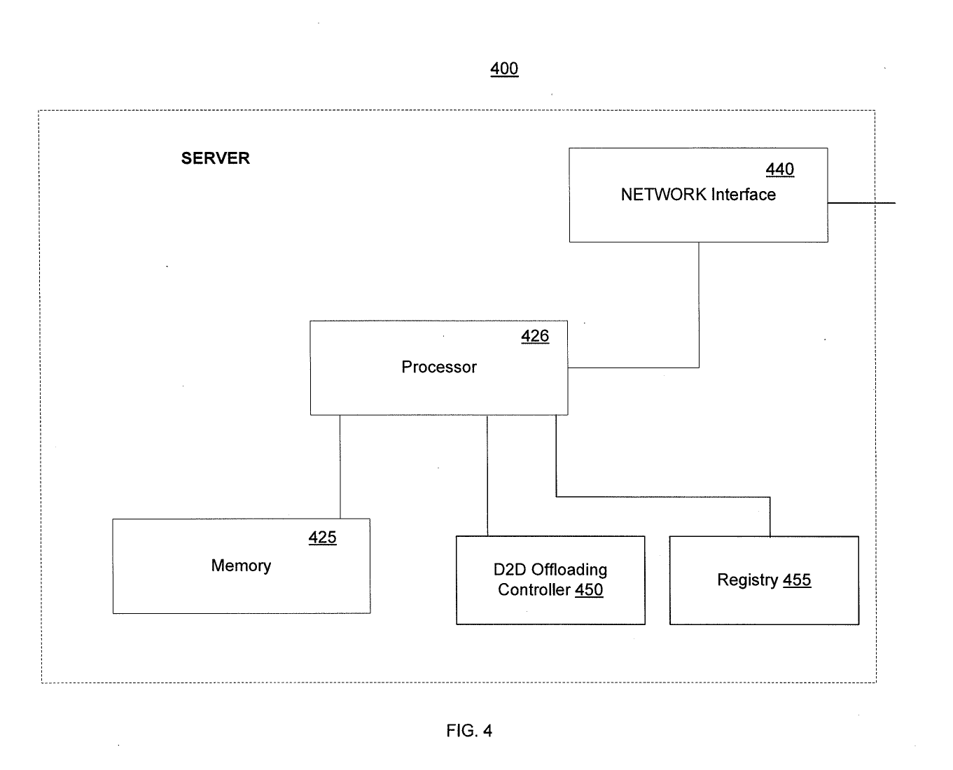

FIG. 4 depicts an example implementation of a server 400, which may be implemented at server 190. The server 400 may include a network interface 440 for accessing the internet, other servers, and/or base station/wireless access point 110. The server 190 may further includes a processor 426 for controlling the server and for accessing and executing program code stored in memory 425. Furthermore, the server 400 may include a D2D offloading controller 450. In some exemplary embodiments, the D2D offloading controller 450 may perform one or more of the D2D offloading related mechanisms described herein including determining the locality of information, and the like. Moreover, the server 400 may further include a registry 455. The registry 455 may include information including the identity of files served by server 400, the user equipment registered at server 190, and the location of files stored in memory/cache at the user equipment. Tables 1 and 2 above depict examples of some of the information that may be maintained by registry 455, although the information depicted in Tables 1 and 2 may be stored in other formats as well.

In some exemplary embodiments, a user equipment and a server exchange locality information on a need-to-know basis and correlate data locality information with device locality information. This correlation may allow both the user equipment and the server to detect when a request can be routed to a user equipment and served locally by another user equipment via D2D communication links, offloading the traffic associate with the requested data to the D2D communication links.

The subject matter described herein may be embodied in systems, apparatus, methods, and/or articles depending on the desired configuration. For example, the user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “machine-readable medium” refers to any computer program product, computer-readable medium, apparatus and/or device (e.g., magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. Moreover, although the above examples describe the ad hoc networks as a device-to-device pair of devices, the devices may be organized into a wireless local area network including a cluster of two or more devices. In addition, the logic flow depicted in the accompanying figures and/or described herein does not require the particular order shown, or sequential order, to achieve desirable results. Other embodiments may be within the scope of the following claims.

What is claimed:

1. A method comprising:
processing information indicating at least one or more data locations representing at least one or more candidate locations where data is stored;
determining at least one or more device locations representing one or more devices accessible by a wireless device-to-device communication link;
determining, based on the one or more data locations and the one or more device locations, a local device from which to access the data; and
accessing the data at the determined local device.

2. The method of claim 1, further comprising:
sending a request for the data.

3. The method of claim 1, further comprising:
sending, by a server, the information indicating at least the one or more data locations.

4. The method of claim 1, further comprising:
receiving the information indicating at least the one or more data locations.

5. The method of claim 1, wherein the information indicating at least the one or more data locations comprises one or more identifiers of the one or more devices.

6. The method of claim 1, wherein the information indicating at least the one or more data locations comprises a cache device set.

7. The method of claim 1, wherein the determining at least the one or more device locations further comprises:
generating a local device set by listening for the one or more devices.

8. The method of claim 1, wherein the determining, based on the one or more data locations and the one or more device locations, the local device further comprises:
comparing the one or more data locations and the one or more device locations to determine the local device.

9. The method of claim 1, wherein the accessing further comprises:
creating at least one device-to-device communication link to access the data at the determined local device.

10. The method of claim 1, wherein the one or more devices and the local device each comprise user equipment.

11. An apparatus comprising
at least one processor; and
at least one memory including computer program code, the at least one memory and the computer program code configured to, with the at least one processor, cause the apparatus to provide operations comprising:
processing information indicating at least one or more data locations representing at least one or more candidate locations where data is stored;
determining at least one or more device locations representing one or more devices accessible by a wireless device-to-device communication link;
determining, based on the one or more data locations and the one or more device locations, a local device from which to access the data; and
accessing the data at the determined local device.

12. The apparatus of claim 11, further comprising:
sending, by a device, a request for the data.

13. The apparatus of claim 11, further comprising:
sending, by a server, the information indicating at least the one or more data locations.

14. The apparatus of claim 11, further comprising:
receiving, at a device, the information indicating at least the one or more data locations.

15. A computer program product comprising machine-readable medium storing instructions that, when executed by at least one processor, cause the at least one processor to perform operations comprising:
processing information indicating at least one or more data locations representing at least one or more candidate locations where data is stored;
determining at least one or more device locations representing one or more devices accessible by a wireless device-to-device communication link;
determining, based on the one or more data locations and the one or more device locations, a local device from which to access the data; and
accessing the data at the determined local device.

16. A method comprising:
storing, at a server, information indicating at least one or more data locations representing at least one or more candidate locations where data is stored in one or more user equipment; and
sending, by the server, the information to enable a determination, based on the one or more data locations and one or more user equipment locations, of a local user equipment from which to access the data.

17. The method of claim 16, wherein the local user equipment is accessed via a wireless device-to-device communication link.

18. The method of claim 16, further comprising:
sending, by the server, a request for the one or more user equipment locations to enable the server to determine the local user equipment from which to access the data.

19. The method of claim 16, further comprising:
registering, at the server, the one or more user equipment.

20. An apparatus comprising
at least one processor; and
at least one memory including computer program code, the at least one memory and the computer program code configured to, with the at least one processor, cause the apparatus to provide operations comprising:
storing, at a server, information indicating at least one or more data locations representing at least one or more candidate locations where data is stored in one or more user equipment; and
sending, by the server, the information to enable a determination, based on the one or more data locations and one or more user equipment locations, of a local user equipment from which to access the data.

21. A computer program product comprising machine-readable medium storing instructions that, when executed by at least one processor, cause the at least one processor to perform operations comprising:
storing, at a server, information indicating at least one or more data locations representing at least one or more candidate locations where data is stored in one or more user equipment; and
sending, by the server, the information to enable a determination, based on the one or more data locations and one or more user equipment locations, of a local user equipment from which to access the data.
